(19) United States
(12) Patent Application Publication
(10) Pub. No.: US 2026/0105580 A1
(43) Pub. Date: Apr. 16, 2026

(54) SEGMENTING DIGITAL DESIGNS INTO LAYERS USING CUSTOM SEGMENTATION AND COLOR PROCESSING

(71) Applicant: Adobe Inc., San Jose, CA (US)

(72) Inventors: Rahul Kumar Saraogi, Noida (IN); Ankur Singh, Noida (IN); Nimish Srivastav, Gurugram (IN); Subbiah Muthuswamy Pillai, Noida (IN); Varun Varshney, Noida (IN); Ashutosh Sharma, Noida (IN)

(21) Appl. No.: 18/912,891

(22) Filed: Oct. 11, 2024

(51) Int. Cl. G06T 5/77; G06T 7/12; G06T 7/194; G06T 7/50; G06T 7/90; G06V 10/25; G06V 10/26

(52) U.S. Cl. CPC G06T 5/77; G06T 7/12; G06T 7/194; G06T 7/50; G06T 7/90; G06V 10/25; G06V 10/26; G06T 2207/10024

(57) ABSTRACT

The present disclosure relates to systems, non-transitory computer-readable media, and methods that detect, utilizing a shape detection neural network, one or more shapes depicted in a digital image. The disclosed systems identify, from the one or more shapes depicted in the digital image, a background region comprising background pixels depicted in the digital image. The disclosed systems determine that the background region depicts solid fill pixels. The disclosed systems determine a prominent color for the solid fill pixels based on determining that the background region depicts solid fill pixels. The disclosed systems generate, from the prominent color, an image layer for the digital image.

### BACKGROUND

Digital images, including graphic designs, often portray elements arranged to communicate information in a precise and appealing manner. Because digital images often consist of multimodal components (e.g., objects, shapes, and text), the layout of a digital image is vital for directing attention and enhancing visual appeal. Over time, technologies have emerged to separate the visual components of digital images into discrete layers to aid in arranging and modifying individual elements. Despite these advances, however, many conventional systems exhibit a number of deficiencies or drawbacks, particularly in accurately and reliably extracting and segmenting visual components into separate layers.

### SUMMARY

Embodiments of the present disclosure provide benefits and/or solve one or more of the foregoing or other problems in the art with systems, non-transitory computer-readable media, and methods for generating image layers from a digital image through a unique segmentation and color processing approach. For example, the disclosed systems train and utilize a shape detection neural network to detect shapes (e.g., geometric shapes) depicted in a digital image. Along with detecting shapes, in some embodiments, the disclosed systems detect objects and text components of the digital image as well. From the logical segments of text, objects, and shapes, in one or more embodiments, the disclosed systems determine a background region of the digital image. In some cases, the disclosed systems further utilize a unique solid fill algorithm to determine whether the background region and/or various detected shapes depict solid fill pixels. In some embodiments, the disclosed systems also utilize a prominent color algorithm to determine a prominent fill color of solid fill pixels for backgrounds and/or shapes. In certain embodiments, the disclosed systems generate image layers using the logical segments of text, objects, shapes, and a background region by filling background pixels and/or shape pixels with a prominent color. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example system environment in which an image layering system operates in accordance with one or more embodiments.

FIG. 2 illustrates an example overview of generating image layers from a digital image in accordance with one or more embodiments.

FIG. 3 illustrates an example diagram of training a shape detection neural network in accordance with one or more embodiments.

FIG. 4 illustrates an example diagram of implementing a solid fill algorithm in accordance with one or more embodiments.

FIG. 5 illustrates an example diagram of implementing a prominent color algorithm in accordance with one or more embodiments.

FIG. 6 illustrates an example image editing interface depicting extracted image layers in accordance with one or more embodiments.

FIG. 7 illustrates a schematic diagram of an image layering system in accordance with one or more embodiments.

FIG. 8 illustrates an example series of acts for generating image layers in accordance with one or more embodiments.

FIG. 9 illustrates an example series of acts for training a shape detection neural network in accordance with one or more embodiments.

FIG. 10 illustrates an example series of acts for generating image layers in accordance with one or more embodiments.

FIG. 11 illustrates a block diagram of an example computing device for implementing one or more embodiments of the present disclosure.

### DETAILED DESCRIPTION

This disclosure describes one or more embodiments of an image layering system that generates or extracts layers from digital images using a segmentation process, and a pixel filling approach based on prominent fill colors. For example, the image layering system segments a digital image into different logical segments, including text segments, object segments, and shape segments using respective segmentation models. As part of the segmentation process, in some embodiments, the image layering system utilizes a shape segmentation neural network specially trained on template images to detect geometric shapes, including occluded shapes and partial shapes. In some embodiments, the image layering system determines a background region of the digital image from the logical segments, including the shapes, objects, and text. In some cases, the image layering system further processes the background region and/or detected shapes to determine whether they depict solid fill pixels. For a background region and/or a shape that depicts solid fill pixels, in certain embodiments, the image layering system determines a prominent fill color for the solid fill pixels and applies a fill to the entire background/shape using the prominent fill color to ensure uniformity and accuracy in filling any holes or errors from the segmentation process. In some embodiments, the image layering system generates a set of image layers corresponding to the set of logical segments (including filled shapes and background), where each layer is manipulable independently to modify the digital image.

As just mentioned, in some embodiments, the image layering system performs a segmentation process to extract text segments, object segments, and shape segments from a digital image. In some embodiments, the segmentation process involves utilizing a shape detection neural network to detect shapes in a digital image. For example, the image layering system utilizes a shape detection neural network to detect geometric shapes (e.g., rectangles, triangles, ellipses, and other shapes) depicted in the digital image, even if the geometric shapes are partial, occluded, or otherwise incomplete. In some cases, the image layering system trains the shape detection neural network by identifying and utilizing a unique training dataset that includes template images depicting occluded, partial, and/or otherwise incomplete geometric shapes.

In addition, in one or more embodiments, the image layering system determines whether detected shapes and/or a background region of a digital image depict solid fill pixels. For example, the image layering system utilizes a solid fill algorithm to text a shape and/or a background region. In some cases, the solid fill algorithm involves using a color tag model to determine color values of pixels in a shape or a background region. In some embodiments, the solid fill algorithm includes using one or more thresholds and color binning techniques to determine whether a shape or a background region is a solid fill or not.

As noted, in some embodiments, the image layering system determines a prominent fill color for a solid fill shape and/or a solid fill background region. For example, upon determining that a shape and/or a background region depict solid fill pixels, the image layering system utilizes a prominent color algorithm to determine a prominent fill color for the solid fill pixels. In some cases, the prominent color algorithm includes a color conversion process, a color binning technique, and a similarity determination process. Based on the prominent color algorithm, in some embodiments, the image layering system fills a shape and/or a background region with a prominent fill color and generates an image layer for the shape and/or the background region.

As suggested above, many conventional systems exhibit a number of shortcomings or disadvantages, particularly in accurately and reliably extracting and segmenting visual components into separate layers. To elaborate, many existing systems that attempt to extract separate layers from a single (non-layered or single-layered) image often create holes of missing or spurious pixels, particularly when separating image components (e.g., objects or text) that overlap or occlude one another. In efforts to remediate such issues, some existing systems utilize inpainting techniques to fill the holes created in various image components through the segmentation process. However, the inpainting process of existing systems often generates a significant amount of noise in inpainted regions, resulting in uneven, nonuniform colors.

Due at least in part to their inaccuracies, many prior systems are also inefficient. More specifically, existing systems often require excessive numbers of client device interactions to modify and correct inpainted regions generated using existing inpainting methods. In many cases, the number of interactions required to correct the amounts of spurious noisy pixels becomes onerous and prohibitively time-consuming. Not only do such prior systems result in inefficient client device interactions, but processing the large numbers of interactions and applying the corresponding image edits consumes excessing computational resources (e.g., processing power and memory) that could otherwise be preserved with a more efficient system.

As suggested above, embodiments of the image layering system provide certain improvements or advantages over conventional systems. For example, embodiments of the image layering system improve accuracy in extracting layers from a digital image. As opposed to prior systems that generate error-prone image layers with holes and/or noisy pixels, the image layering system utilizes a shape detection neural network, a solid fill algorithm, and a pixel color algorithm to accurately segment shapes and background regions and to accurately fill the shapes and background regions with prominent fill colors. Consequently, the image layering system generates image layers that accurately represent or reflect shapes and background regions for independent manipulation and editing.

Due at least in part to its improved accuracy, certain embodiments of the image layering system also improve efficiency relative to prior systems. While many prior systems require excessive numbers of device interactions to correct holes and/or noisy pixels, the image layering system reduces or eliminates such holes and/or noisy pixels using the segmentation and prominent color filling techniques described. By so doing, the image layering system greatly reduces the number of device interactions for image editing. The image layering system thus improves efficiency not only by reducing interactions but also through reducing the computational expense of processing device interactions and the corresponding images edits (which can be significant for correcting large areas of spurious pixels in many cases).

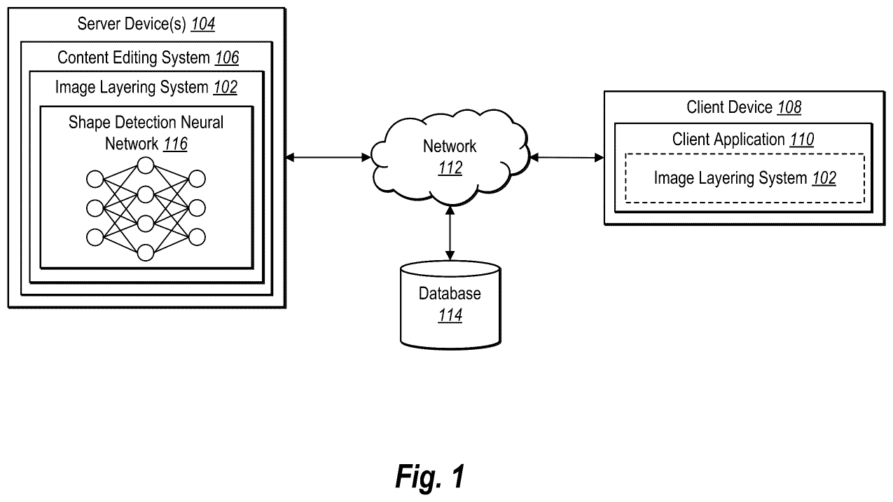

Additional detail regarding the image layering system will now be provided with reference to the figures. For example, FIG. 1 illustrates a schematic diagram of an example system environment for implementing an image layering system 102 in accordance with one or more embodiments. An overview of the image layering system 102 is described in relation to FIG. 1. Thereafter, a more detailed description of the components and processes of the image layering system 102 is provided in relation to the subsequent figures.

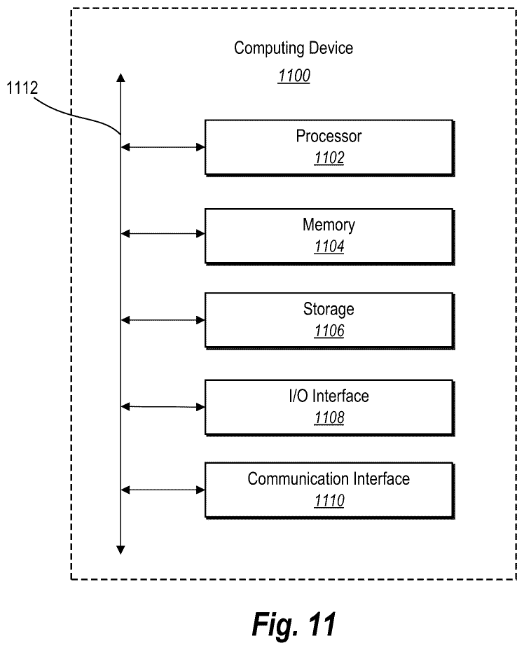

As shown, the environment includes server device(s) 104, a client device 108, a database 114, and a network 112. Each of the components of the environment communicate via the network 112, and the network 112 is any suitable network over which computing devices communicate. Example networks are discussed in more detail below in relation to FIG. 11.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 11. Although FIG. 1 illustrates a single instance of the client device 108, in some embodiments, the environment includes multiple different client devices, each associated with a different user. The client device 108 communicates with the server device(s) 104 and/or the content editing system 106 via network 112. For example, the client device 108 receives inputs, such as uploads or selections digital images, image edits, and/or selections of an image layering option, and the client device 108 provides information to server device(s) 104 indicating digital images and/or a selection to extract layers from a digital image.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server device(s) 104. The client application 110 presents or displays information to a user, including an image editing user interface for extracting separate image layers and/or performing image edits, as provided via the client device 108.

As also illustrated in FIG. 1, the environment includes the server device(s) 104. The server device(s) 104 generates, tracks, stores, processes, receives, and transmits electronic data, such as digital images, image layers, shapes, solid fill data, and/or prominent color data. For example, the server device(s) 104 receives data from the client device 108 in the form of a request to separate a digital image into layers. In response, the server device(s) 104 provides data to the client device 108 in the form of a set of image layers generated using the shape detection neural network 116 that is trained as described herein. For example, the server device(s) 104 communicate with the database 114 to generate one or more training datasets of template images for training the shape detection neural network 116.

In some embodiments, the server device(s) 104 communicates with the client device 108 to transmit and/or receive data via the network 112. In some embodiments, the server device(s) 104 comprises a distributed server where the server device(s) 104 includes a number of server devices distributed across the network 112 and located in different physical locations. The server device(s) 104 comprise a content server, an image editing server, an application server, a communication server, a web-hosting server, a multidimensional server, or a machine learning server.

As further shown in FIG. 1, the server device(s) 104 also includes the image layering system 102 as part of a content editing system 106. For example, in one or more implementations, the content editing system 106 stores, generates, modifies, edits, enhances, provides, distributes, and/or shares digital content, such as digital images. For example, the content editing system 106 provides digital content for editing and/or facilitates other forms of digital processing. In some implementations, the content editing system 106 provides digital content to particular digital profiles associated with client devices (e.g., the client device 108).

In one or more embodiments, the server device(s) 104 includes all, or a portion of, the image layering system 102. For example, the image layering system 102 operates on the server device(s) 104 to generate or modify one or more datasets, such as a training dataset for the shape detection neural network 116. In some embodiments, the client device 108 includes all or part of the image layering system 102. For example, the client device 108 generates, obtains (e.g., downloads), or uses one or more aspects of the image layering system 102, such as the shape detection neural network 116. Indeed, in some implementations, as illustrated in FIG. 1, the image layering system 102 is located in whole or in part of the client device 108 (e.g., as part of the client application 110). For example, the image layering system 102 includes a web hosting application that allows the client device 108 to interact with the server device(s) 104. To illustrate, in one or more implementations, the client device 108 accesses a web page supported and/or hosted by the server device(s) 104.

In one or more embodiments, the client device 108 and the server device(s) 104 work together to implement the image layering system 102. For example, in some embodiments, the server device(s) 104 train one or more neural networks (e.g., the shape detection neural network 116) and provide the one or more neural networks to the client device 108 for implementation. In some embodiments, the server device(s) 104 trains one or more neural networks together with the client device 108.

Although FIG. 1 illustrates a particular arrangement of the environment, in some embodiments, the environment has a different arrangement of components and/or may have a different number or set of components altogether. For instance, as mentioned, the image layering system 102 is implemented by (e.g., located entirely or in part on) the client device 108. As another example, the shape detection neural network 116 is stored within the database 114. In addition, in one or more embodiments, the client device 108 communicates directly with the image layering system 102, bypassing the network 112.

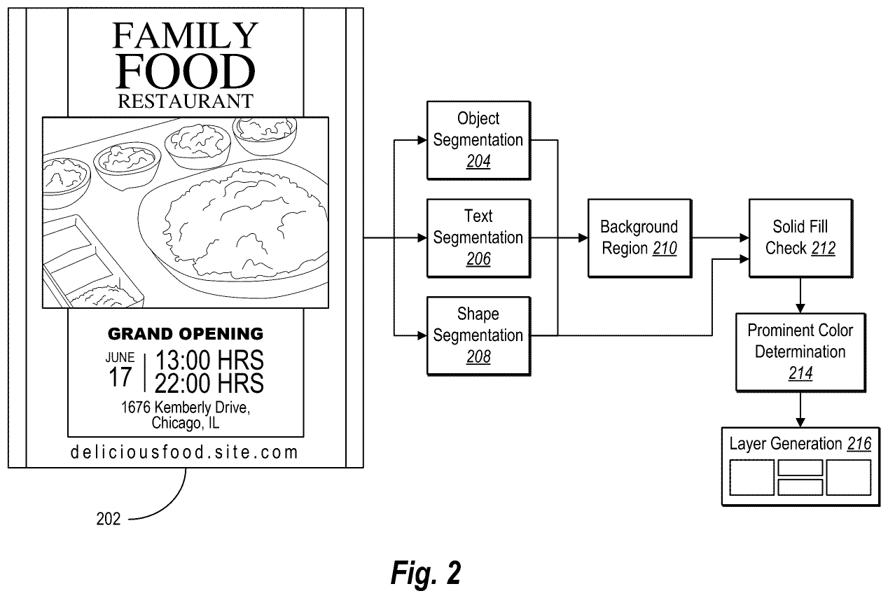

As mentioned, in one or more embodiments, the image layering system 102 generates or extracts layers from a digital image using a unique segmentation and color fill process. In particular, the image layering system 102 utilizes a shape detection neural network together with a solid fill algorithm and a pixel color algorithm to generate image layers for a digital image. FIG. 2 illustrates an example overview of generating image layers from a digital image in accordance with one or more embodiments. Additional detail regarding the various processes and functions introduced in relation to FIG. 2 is provided thereafter with reference to subsequent figures.

As illustrated in FIG. 2, the image layering system 102 receives a digital image 202. In particular, the image layering system 102 receives the digital image 202 as an upload, a selection from an image repository, and/or as a generated image from an image editing application (e.g., the client application 110). As shown, the digital image 202 depicts a graphic design for a restaurant, including a restaurant name, an image of food on a table, timing information, and a website.

As further illustrated in FIG. 2, the image layering system 102 utilizes a segmentation process to generate or extract a set of logical segments from the digital image 202. More specifically, the image layering system 102 generates or extracts object segments using object segmentation 204. For example, the image layering system 102 performs object segmentation 204 by using an object segmentation model (e.g., a neural network). Indeed, the image layering system 102 utilizes an object segmentation model trained to detect depicted objects, such as overlaid images, people, cars, dinnerware, plants, or other generated objects. In some cases, the image layering system 102 detects and extracts objects by detecting edges and/or pixel color differences across the digital image 202. The image layering system 102 thus generates object segments from the digital image 202 for ultimately including in image layers.

In one or more embodiments, a neural network (e.g., a content-conditioned variational generative model) includes or refers to a machine learning model that is trainable and/or tunable based on inputs to generate predictions, determine classifications, or approximate unknown functions. For example, a neural network includes a model of interconnected artificial neurons (e.g., organized in layers) that communicate and learn to approximate complex functions and generate outputs (e.g., logical segments, such as objects, text, or shapes) based on a plurality of inputs provided to the neural network. In some cases, a neural network refers to an algorithm (or set of algorithms) that implements deep learning techniques to model high-level abstractions in data. For example, a neural network includes a deep neural network, a convolutional neural network, a recurrent neural network (e.g., an LSTM), a graph neural network, a transformer, or a generative neural network (e.g., a generative adversarial neural network, a variational autoencoder, or a diffusion neural network).

In addition, the image layering system 102 generates or extracts text segments using text segmentation 206. For instance, the image layering system 102 performs the text segmentation 206 using a text segmentation model (e.g., a neural network) trained to detect and extract text content (e.g., characters or symbols) depicted in a digital image. In some cases, the image layering system 102 identifies depicted text and generates a single text segment for all text. In other cases, the image layering system 102 generates multiple text segments for text depicted in different regions or portions of the digital image 202, such as text overlaid on different objects or shapes, text having different characteristics (e.g., size, shape, font, and/or color), and/or text conveying different types of information (e.g., title, timing information, and website). The image layering system 102 thus generates one or more text segments from the digital image 202 for ultimately including in image layers.

As further illustrated in FIG. 2, the image layering system 102 performs a shape segmentation 208 to generate or extract shape segments from the digital image 202. In particular, the image layering system 102 utilizes a shape detection neural network trained to detect geometric shapes (e.g., ellipses, rectangles, triangles, and other geometric shapes) depicted in digital images, even if the geometric shapes are partial or occluded. In some embodiments, the image layering system 102 trains the shape detection neural network using a specialized training dataset that includes template images depicting geometric shapes, including occluded (e.g., partially occluded), partial, and/or otherwise incomplete (e.g., with missing and/or noisy pixels) geometric shapes. In some cases, a shape detection neural network includes or refers to a neural network trained to detect geometric shapes, including backing shapes behind or underlying featured content, such as text or objects. The image layering system 102 thus generates or trains a shape detection neural network capable of detecting occluded or partial geometric shapes and utilizes the shape detection neural network to detect shapes depicted in the digital image 202.

As also illustrated in FIG. 2, the image layering system 102 generates a background region 210. To elaborate, the image layering system 102 generates a background region 210 based on the object segmentation 204, the text segmentation 206, and the shape segmentation 208. For example, the image layering system 102 determines the background region as a set of pixels that remain after removing or omitting the object segments, the text segments, and the shape segments from the digital image 202. In some cases, a background region includes or refers to a layer or a set of pixels farthest from an observer (e.g., at the deepest level in a digital image) with other content lying on top. In some embodiments, the image layering system 102 determines the background region 210 as a shape (e.g., from the shape segments) underlying all other shapes, objects, and text in the digital image 202.

In one or more embodiments, the image layering system 102 performs a solid fill check 212. More particularly, the image layering system 102 performs the solid fill check 212 by utilizing a solid fill algorithm. In some embodiments, a solid fill algorithm includes or refers to a computer executable set of functions or processes that generates a determination or a probability that an area (e.g., a background region or an extracted shape) is filled with a solid pixel color. The image layering system 102 thus utilizes the solid fill algorithm to determine whether a background and/or a shape depicts solid fill pixels. Indeed, in some cases, solid fill pixels include or refer to pixels that are filled with a solid color (e.g., of a single color value or within a range of color values).

As further illustrated in FIG. 2, the image layering system 102 performs a prominent color determination 214. In one or more embodiments, the image layering system 102 performs the prominent color determination 214 by utilizing a prominent color algorithm. In some embodiments, a prominent color algorithm includes or refers to a computer executable set of functions or processes that generates a determination or a probability that a solid fill area (e.g., a background region or an extracted shape) depicts a particular prominent fill color. In some cases, the image layering system 102 thus utilizes a prominent color algorithm to determines a prominent fill color, including an indication of a color value (or a range of color values) defining the prominent fill color. Indeed, in some cases, a prominent fill color (or a prominent color) includes or refers to a color value (or a range of color values) defining a depicted color for solid fill pixels.

Additionally, in one or more embodiments, the image layering system 102 performs layer generation 216. In particular, the image layering system 102 generates image layers from the logical segments extracted via the object segmentation 204, the text segmentation 206, and the shape segmentation 208. In some cases, the layer generation 216 generates a set of image layers for depicted objects, text, shapes, and/or the background region 210. The image layering system 102 thus generates image layers that are independently manipulable and editable to generate modified digital images from the digital image 202.

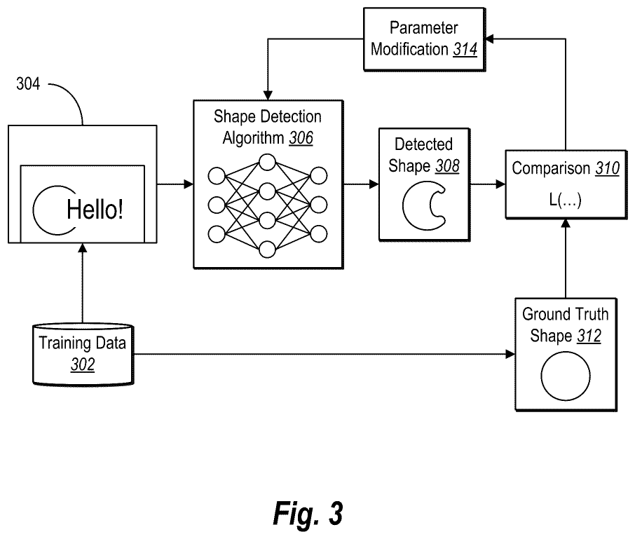

As noted above, in certain described embodiments, the image layering system 102 trains and implements a shape detection neural network to detect geometric shapes. In particular, the image layering system 102 generates and utilizes a specialized training dataset that includes template images depicting partial and/or occluded geometric shapes. FIG. 3 illustrates an example diagram for training a shape detection neural network to detect geometric shapes in accordance with one or more embodiments.

As illustrated in FIG. 3, the image layering system 102 generates, identifies, or receives training data 302. In particular, the image layering system 102 determines the training data 302 by selecting, from a repository of digital images (e.g., Adobe Express templates), a subset of digital images depicting geometric shapes. In some cases, the image layering system 102 selects, for the training data 302, digital images that depict partially occluded geometric shapes (including images where only 5% to 10% of a geometric shape is visible or un-occluded), geometric shapes with holes or missing pixels, and/or geometric shapes that include noisy or spurious pixels. The image layering system 102 thus generates the training data 302 as a dataset for training a shape detection neural network 306. As part of generating the training data 302, the image layering system 102 further selects template images that prevent the shape detection neural network 306 from over-detecting shapes, such as shapes inside other objects (identified via object segmentation) that should not be identified (which is a problem research has identified in existing detection models).

As shown, the image layering system 102 further provides a template image 304 to the shape detection neural network 306. Indeed, the image layering system 102 selects the template image 304 from the training data 302. As shown, the template image 304 depicts a rectangular background with text (“Hello!”) overlaid on a circular geometric shape. Analyzing the template image, the shape detection neural network 306 generates or predicts a detected shape 308. In particular, the shape detection neural network 306 analyzes the template image 304 using its internal parameters to generate an outline and/or a bounding box defining an area of pixels depicting a geometric shape in the template image 304.

In some cases, the shape detection neural network 306 includes a particular architecture made up of a backbone network, a feature pyramid network, and a region proposal network. For instance, the backbone network includes a number of convolutional layers that extract hierarchical feature maps at multiple scales for downstream processing. The feature pyramid enhances the feature maps by combining low-resolution, semantically strong features with high-resolution, semantically weak features. The region proposal network generates proposals of candidate bounding boxes for detected shapes based on the output of the feature pyramid network.

As further illustrated in FIG. 3, the image layering system 102 performs a comparison 310. To elaborate, the image layering system 102 compares the detected shape 308 with a ground truth shape 312 stored in the training data 302. Indeed, the image layering system 102 determines the ground truth shape 312 as an actual geometric shape depicted in the template image 304. Thus, the image layering system 102 performs the comparison 310 to compare the prediction of the detected shape 308 with the ground truth shape 312. In some cases, the image layering system 102 utilizes one or more loss functions, such as a classification loss (for classifying a shape), a bounding box regression loss (for bounding boxes of shapes), and/or a mask prediction loss (for different shape instances) as part of the comparison 310.

In addition, the image layering system 102 performs a parameter modification 314. More specifically, the image layering system 102 modifies parameters of the shape detection neural network 306 based on the comparison 310. For example, the image layering system 102 modifies internal weights and biases associated with neurons and layers of the shape detection neural network 306 to modify its behavior and analysis of input data. In some cases, the image layering system 102 modifies parameters to reduce one or more measures of loss associated with one or more architectural components of the shape detection neural network 306. Over multiple iterations or epochs of detecting shapes from template images and updating parameters based comparing detected shapes with ground truth shapes, the image layering system 102 thus trains the shape detection neural network 306 until its generated predictions of detected shapes satisfy loss thresholds for one or more loss functions.

Based on the training illustrated in FIG. 3, the image layering system 102 can thus deploy and implement the shape detection neural network 306 to detect shapes depicted in digital images. Indeed, by training the shape detection neural network 306 on the training data 302, the image layering system 102 utilizes the shape detection neural network 306 to even detect occluded, partial, and otherwise incomplete geometric shapes in digital images. The image layering system 102 thus detect geometric shapes in digital images.

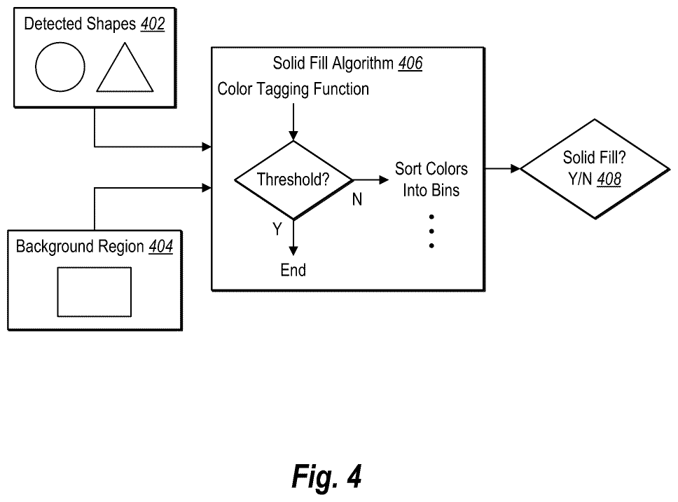

As mentioned above, in certain described embodiments, the image layering system 102 determines whether a detected shape and/or a background region depicts solid fill pixels. In particular, the image layering system 102 utilizes a solid fill algorithm to analyze shapes and/or background regions to determine whether they are filled with solid pixel colors. FIG. 4 illustrates an example diagram of determining solid fill pixels in accordance with one or more embodiments.

As illustrated in FIG. 4, the image layering system 102 identifies detected shapes 402. In particular, the image layering system 102 generates or extracts the detected shapes 402 using a shape detection neural network as described above. In some cases, the image layering system 102 implements a shape detection neural network extract or identify multiple geometric shapes from a single digital image, where each shape is separated into its own logical segment.

As also illustrated in FIG. 4, the image layering system 102 generates or identifies a background region 404. More specifically, the image layering system 102 generates the background region 404 based on generating a set of logical segments from a digital image. Indeed, as noted above, the image layering system 102 generates object segments, text segments, and/or shape segments from a digital image. In some cases, the image layering system 102 further determines the background region 404 as a group of pixels remaining after removing all of the logical segments. In other cases, the image layering system 102 determines the background region 404 as a detected shape that underlies (or is farthest from a user viewpoint) all other shapes and other logical segments. As shown, the background region 404 is a rectangular pixel region having dimensions and resolution corresponding to that of the initial digital image.

As shown, the image layering system 102 further utilizes a solid fill algorithm 406 to analyze the detected shapes 402 and the background region 404. To elaborate, the image layering system 102 utilizes the solid fill algorithm 406 to implement a color tagging function. As part of the solid fill algorithm 406, the image layering system 102 calls or instantiates the Adobe Color Tag service (or another color tagging function) to determine or extract color data from the detected shapes 402 and/or the background region 404. Indeed, the image layering system 102 utilizes the color tagging function to generate a color palette of colors depicted by pixels in one or more formats including RGB (red, green, blue), LAB (luminance, green-red axis, yellow-blue axis), or some other color space.

In some cases, the image layering system 102 further utilizes the color tagging function to determine an area and/or a percentage of coverage associated with color values identified in the detected shapes 402 and/or the background region 404. For instance, as part of the solid fill algorithm 406, the image layering system 102 determines a color value of a detected shape and further determines a number of pixels or an area covered by the color value. Comparing the pixel area of the color value, the image layering system 102 determines a coverage percentage in relation to the shape/background region. In some cases, the color tagging function generates results in a Java Script Object Notation (JSON) format, such as the following example: {‘Beige’: (0.7554, (246, 226, 185)), ‘Cream’: (0.0989, (243, 229, 177)), ‘Red’: (0.0249, (185, 50, 40))} {‘Beige’: (0.4873, (238, 203, 158)), ‘Orange’: (0.4728, (235, 203, 157)), ‘Olive’: (0.04, (180, 165, 133))} {‘Brown’: (0.7764, (204, 107, 70)), ‘Orange’: (0.2236, (207, 109, 72))}, where the first number indicates a coverage percentage of the indicated color, and the other three values are RGB values corresponding to the color or bin. The image layering system 102 thus parses the JSON object(s) and sorts based on coverage percentage.

In addition, the image layering system 102 compares the coverage percentage with a solid fill threshold to determine whether the shape/background region depicts solid fill pixels. If the coverage percentage satisfies the solid fill threshold, the image layering system 102 determines that the shape/background region is a solid fill (e.g., depicts solid fill pixels). If not, the image layering system 102 determines that additional processing is necessary.

Based on determining that the coverage percentage does not satisfy the solid fill threshold, as part of the solid fill algorithm 406, the image layering system 102 performs additional color analysis. Indeed, some color tagging functions utilize a fixed number (e.g., 40) of color bins for classifying color values, and color values that are in a range which falls into more than one adjacent color bin may still represent solid fill pixels even if they are in separate bins which do not individually satisfy the solid fill threshold. For such edge cases, the image layering system 102 performs further analysis to sort color values returned by the color tagging function. More specifically, the image layering system 102 sorts and groups the colors into bins according to their RGB values. For instance, the image layering system 102 bins the colors into RGB value bins that each define a certain area (or threshold distance from one another) in the color space.

In addition, the image layering system 102 combines (e.g., sums or adds) the coverage area of pixels in each group or bin. In one or more embodiments, the image layering system 102 thus generates a color coverage list by ordering the groups or bins according to amount or area of coverage (e.g., in descending order with highest areas on top and lowest areas on bottom). Continuing the solid fill algorithm 406, the image layering system 102 further determines or identifies a color group/bin in the list (e.g., the highest ranked group/bin in the list) and compares its coverage area with the solid fill threshold.

In some embodiments, the image layering system 102 implements the solid fill algorithm 406 by executing the following processes. For example, the image layering system 102 determines a top color and a top color coverage from a color tagging function. If the top color coverage is greater than or equal to a threshold coverage, the image layering system 102 determines that the shape/background region is a solid fill and sets the prominent fill color as the top color from the color tagging function. Otherwise, the image layering system 102 generates color coverage groups or bins using a binning/sorting function and generates a ranked list of the groups/bins by adding the coverage areas in each one. Upon sorting the list in descending order of coverage area, the image layering system 102 determines one or more groups/bins in the list that satisfy the coverage threshold, determines that the shape/background region is a solid fill, and sets the most prominent color as an average of color values (e.g., RGB values) in the one or more groups/bins.

By utilizing the solid fill algorithm 406, the image layering system 102 thus makes a solid fill determination 408. Indeed, the image layering system 102 compares binned/grouped color values in the ranked list with the solid fill threshold to determine whether a shape/background region depicts solid fill pixels. If the coverage area of a group/bin satisfies the solid fill threshold, the image layering system 102 designates the shape/background region as a solid fill depicting solid fill pixels. In some cases, the image layering system 102 applies the solid fill algorithm 406 to each of the detected shapes 402 and/or the background region 404 independently to make individual determinations of depicting solid fill pixels.

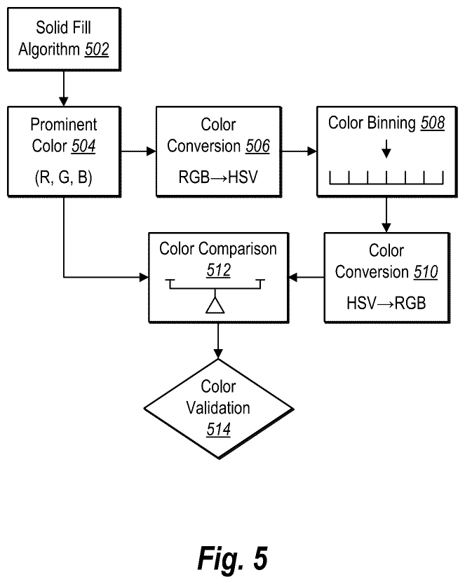

As mentioned above, in one or more embodiments, the image layering system 102 determines and validates a prominent fill color for a solid fill region, such as a shape or a background region. In particular, the image layering system 102 utilizes a prominent color algorithm to determine a prominent fill color for a shape and/or a background region of a digital image. FIG. 5 illustrates an example diagram of a prominent color algorithm for determining a prominent fill color in accordance with one or more embodiments.

As illustrated in FIG. 5, the image layering system 102 determines a prominent fill color 504 based on data from a solid fill algorithm 502. More specifically, the image layering system 102 utilizes the solid fill algorithm 502 to determine whether a shape or a background region depicts solid fill pixels, as described above. As part of the solid fill algorithm 502, the image layering system 102 further determines a prominent fill color 504 as the color selected from the solid fill algorithm 502 as satisfying the solid fill threshold. In some cases, the image layering system 102 determines the prominent fill color 504 by combining multiple colors (e.g., averaging RGB values across color groups or bins) where the solid fill algorithm 502 indicates no single color value from the color tagging function satisfies the solid fill threshold.

As further illustrated in FIG. 5, the prominent color algorithm involves additional functions or processes included in validating the prominent fill color 504. For example, the image layering system 102 performs a color conversion 506. More specifically, the image layering system 102 converts the prominent fill color 504 from a first color space (e.g., RGB) to a second color space (e.g., hue, saturation, value or HSV) using a color conversion function. The image layering system 102 thus determines a hue value for the prominent fill color 504 in the HSV color space.

In addition, the image layering system 102 performs a color binning 508. To elaborate, the image layering system 102 generates a set of bins (e.g., 180 bins) across a spectrum of the HSV color space or encapsulating the entire space. The image layering system 102 further determines a bin for the converted version of the prominent fill color 504 among the HSV color bins. Indeed, each of the HSV color bins covers a range of HSV values, and the image layering system 102 determines which of the bins covers a range where the HSV values of the converted version of the prominent fill color 504 belongs.

As further illustrated in FIG. 5, the image layering system 102 performs a color conversion 510. More particularly, the image layering system 102 converts the HSV values of the identified HSV color bin (for the converted version of the prominent fill color 504) into the RGB color space. In some embodiments, the image layering system 102 thus determines a new, bin-based value for the prominent fill color 504.

As shown, the image layering system 102 further performs a color comparison 512 as part of the prominent color algorithm. For instance, the image layering system 102 compares the prominent fill color 504 with the converted, bin-based version of the prominent fill color 504 (e.g., a converted prominent color). To perform the color comparison 512, the image layering system 102 compares red values, blue values, and green values individually. The image layering system 102 further determines whether the difference in each of the color-specific values is within a threshold difference. If so, the image layering system 102 determines that the colors match (e.g., are treated as the same color value). In some cases, the image layering system 102 sums the RGB values of both colors, determines a difference between the summed values, and determines whether the summed difference is within a threshold difference.

In one or more embodiments, the image layering system 102 performs the color comparison 512 using a Euclidean distance function. To elaborate, the image layering system 102 determines a Euclidean distance between the RGB values of the prominent fill color 504 and the converted prominent color (e.g., by determining the square root of the squares of each color channel:

$$\sqrt{{( {R}_{1} - {R}_{2} )}^{2} + {( {G}_{1} - {G}_{2} )}^{2} + {( {B}_{1} - {B}_{2} )}^{2}} ) .$$

The image layering system 102 considers the two color values as the same color (e.g., identical) if the distance is less than a threshold distance. In some embodiments, the image layering system 102 utilizes both the color-channel-specific differences and the Euclidean distance as part of the color comparison 512. If the RGB distances and the Euclidean distance are within respective threshold values, the image layering system 102 utilizes the prominent fill color 504 as the fill color for the shape/background region. If the RGB distances and/or the Euclidean distance are not within respective thresholds, the image layering system 102 utilizes a new (looser) Euclidean distance threshold and performs another Euclidean distance comparison. I

n one or more embodiments, the image layering system 102 utilizes a prominent color algorithm represented by the following processes. For example, the image layering system 102 determines that a shape/background region is a solid fill and generates a converted prominent fill color as described above. The image layering system 102 determines an RGB distance between the prominent fill color from the solid fill algorithm and the converted prominent fill color. The image layering system 102 also determines a Euclidean distance between the two colors. If the RGB distance is less than or equal to a threshold RGB distance and the Euclidean distance is less than or equal to a threshold Euclidean distance, then the image layering system 102 determines the final prominent fill color for the shape/background region as the prominent fill color from the solid fill algorithm. Otherwise, the image layering system 102 determines that the Euclidean distance is less than or equal to a looser threshold Euclidean distance and sets the final prominent fill color as the most prominent fill color the solid fill algorithm.

Based on the color comparison 512, the image layering system 102 thus determines a color validation 514. Particularly, the image layering system 102 determines a color for filling a shape and/or a background region while preserving or maintaining original properties of the shape/background region. Using the prominent color algorithm, the image layering system 102 effectively and accurately reconstructs solid fill shapes and background regions with decreased user interactions. Indeed, as a product of the improved fill accuracy, the image layering system 102 provides enhanced usability of shapes and background regions that do not require independent interactions to correct spurious, noisy pixels prominent in prior systems.

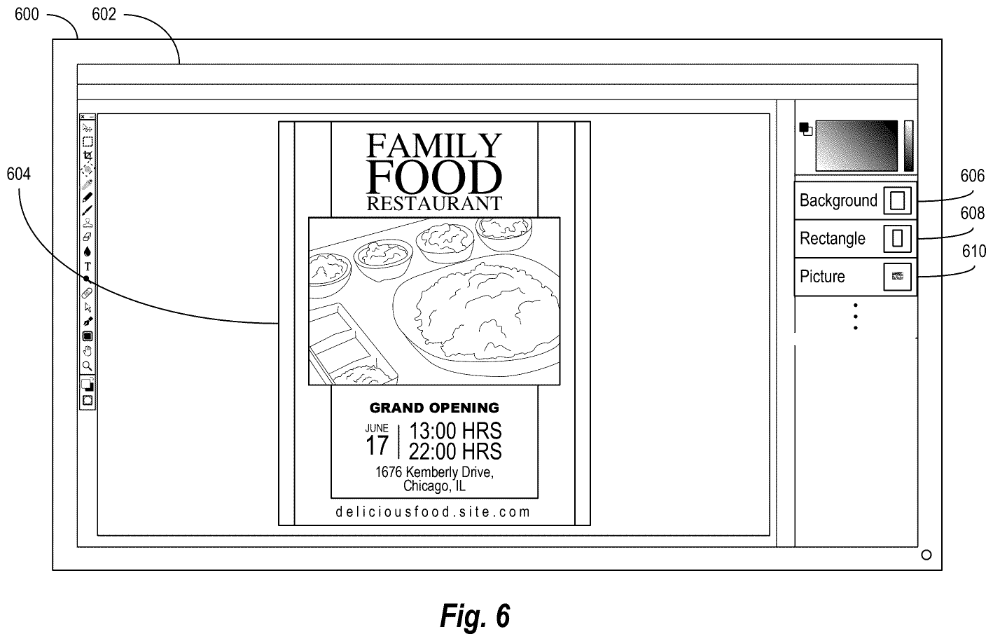

As noted above, in certain described embodiments, the image layering system 102 provides an image editing interface for extracting and managing image layers for a digital image. In particular, the image layering system 102 extracts image layers using the techniques described herein and provides the image layers for individual editing. FIG. 6 illustrates an example image editing interface for generating and utilizing image layers in accordance with one or more embodiments.

As illustrated in FIG. 6, the image layering system 102 provides an image editing interface 602 for display on a client device 600. More particularly, the image layering system 102 extracts image layer 606, image layer 608, and image layer 610 from a digital image 604. To elaborate, the image layering system 102 analyzes the digital image 604 and extracts the image layers using the logical segmentation process, the solid fill algorithm, and the prominent color algorithm described herein.

In one or more embodiments, the image layering system 102 generates the image layer 606 by determining a background region, determining that the background region is a solid fill region, determining a prominent fill color for the background region, and filling the background region with the prominent fill color. In these or other embodiments, the image layering system 102 generates the image layer 608 by extracting a shape using a shape detection neural network, determining that the shape is a solid fill shape, determining a prominent fill color for the shape, and filling the shape with the prominent fill color (e.g., replacing holes left by overlapping text and images). Additionally, the image layering system 102 generates the image layer 610 by extracting an object segment from the digital image 604 using an object detection neural network. The image layering system 102 generates additional image layers from the digital image 604, including text layers, shape layer, and object layers.

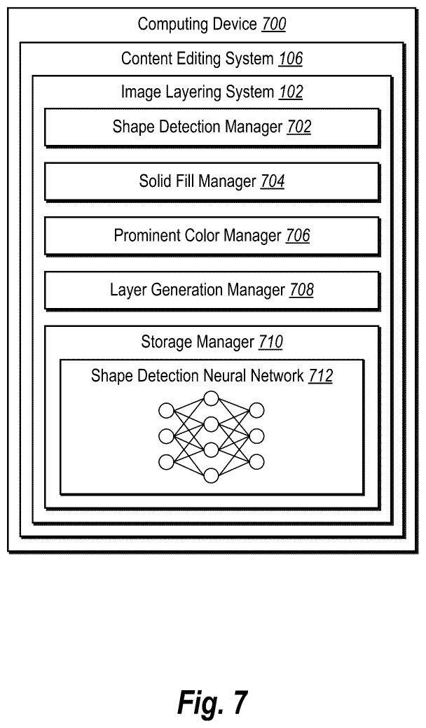

Looking now to FIG. 7, additional detail will be provided regarding components and capabilities of the image layering system 102. Specifically, FIG. 7 illustrates an example schematic diagram of the image layering system 102 on an example computing device 700 (e.g., one or more of the client device 108 and/or the server device(s) 104). In some embodiments, the computing device 700 refers to a distributed computing system where different managers are located on different devices, as described above. As shown in FIG. 7, the image layering system 102 includes a shape detection manager 702, a solid fill manager 704, a prominent color manager 706, a layer generation manager 708, and a storage manager 710.

As just mentioned, the image layering system 102 includes a shape detection manager 702. In particular, the shape detection manager 702 manages, determines, extracts, or identifies shapes depicted in a digital image. In some cases, the shape detection manager 702 trains and utilizes a shape detection neural network 712 using a specialized training dataset. For example, the shape detection manager 702 determines template images that depict occluded or otherwise incomplete geometric shapes and utilizes the template images to train the shape detection neural network 712. In addition, the shape detection manager 702 implements the shape detection neural network 712 trained to detect geometric shapes, even if they are occluded by other objects or text.

As further illustrated, the image layering system 102 includes a solid fill manager 704. In particular, the solid fill manager 704 manages, implements, utilizes, or performs a solid fill algorithm to determine whether a shape and/or a background region depicts solid fill pixels. To elaborate, the solid fill manager 704 utilizes a solid fill algorithm (as described above) to determine that a detected shape and/or a detected background region is/are filled with a solid color.

In addition, the image layering system 102 includes a prominent color manager 706. In particular, the prominent color manager 706 detects, determines, extracts, or identifies a prominent color for a shape and/or a background region of a digital image. For example, the prominent color manager 706 analyzes a shape and/or a background region indicated as depicting solid fill pixels (e.g., via the solid fill manager 704) to further determine a color value of the solid fill pixels. In some cases, the prominent color manager 706 utilizes a prominent color algorithm as described above.

As further illustrated in FIG. 7, the image layering system 102 includes a layer generation manager 708. In particular, the layer generation manager 708 manages, generates, determines, extracts, or identifies image layers from a digital image. For example, the layer generation manager 708 extracts image layers from logical segments of a digital image, including text segments, object segments, and shape segments as described above. In addition, the layer generation manager 708 generates an image layer for a background region determined from a digital image, as described.

The image layering system 102 further includes a storage manager 710. The storage manager 710 operates in conjunction with, or includes, one or more memory devices such as a database (e.g., the database 114) that store various data such as training data template images. As shown, the storage manager 710 stores or manages components of the image layering system 102, including a shape detection neural network 712. In some cases, the shape detection neural network 712 includes an architecture trained to detect shapes as described herein. The storage manager 710 communicates with the other components of the image layering system 102 to facilitate the operations and functions described herein.

In one or more embodiments, each of the components of the image layering system 102 are in communication with one another using any suitable communication technologies. Additionally, the components of the image layering system 102 is in communication with one or more other devices including one or more client devices described above. It will be recognized that although the components of the image layering system 102 are shown to be separate in FIG. 7, any of the subcomponents may be combined into fewer components, such as into a single component, or divided into more components as may serve a particular implementation. Furthermore, although the components of FIG. 7 are described in connection with the image layering system 102, at least some of the components for performing operations in conjunction with the image layering system 102 described herein may be implemented on other devices within the environment.

The components of the image layering system 102, in one or more implementations, includes software, hardware, or both. For example, the components of the image layering system 102 include one or more instructions stored on a computer-readable storage medium and executable by processors of one or more computing devices (e.g., the computing device 700). When executed by the one or more processors, the computer-executable instructions of the image layering system 102 cause the computing device 700 to perform the methods described herein. Alternatively, the components of the image layering system 102 comprises hardware, such as a special purpose processing device to perform a certain function or group of functions. Additionally, or alternatively, the components of the image layering system 102 includes a combination of computer-executable instructions and hardware.

Furthermore, the components of the image layering system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the image layering system 102 may be implemented as part of a stand-alone application on a personal computing device or a mobile device. Alternatively, or additionally, the components of the image layering system 102 may be implemented in any application that allows creation and delivery of marketing content to users, including, but not limited to, applications in ADOBE® EXPERIENCE MANAGER and CREATIVE CLOUD®, such as ADOBE® EXPRESS®, PHOTOSHOP®, ILLUSTRATOR®, and INDESIGN®. “ADOBE,” “ADOBE EXPERIENCE MANAGER,” “CREATIVE CLOUD,” “EXPRESS,” “PHOTOSHOP,” “ILLUSTRATOR,” and “INDESIGN” are either registered trademarks or trademarks of Adobe Inc. in the United States and/or other countries.

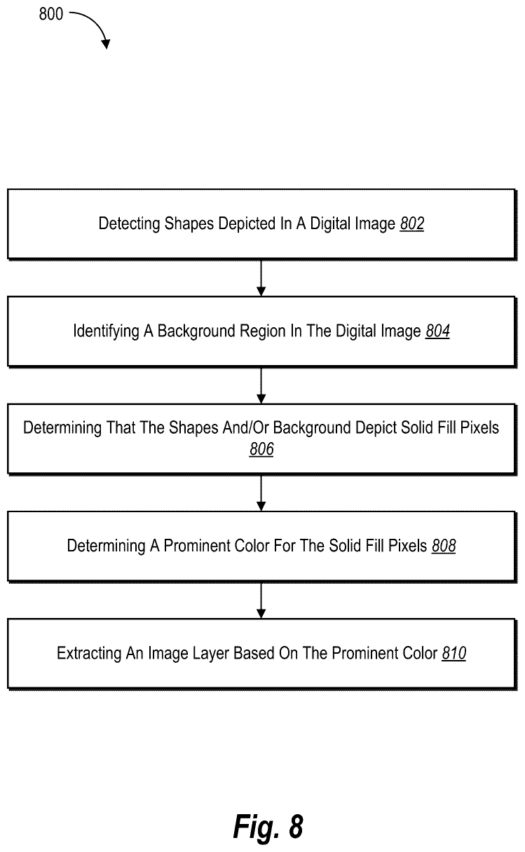

FIGS. 1-7 the corresponding text, and the examples provide a number of different systems, methods, and non-transitory computer readable media for generating or extracting image layers from a digital image using a shape detection neural network, a solid fill algorithm, and a pixel color algorithm. In addition to the foregoing, embodiments are describable in terms of flowcharts comprising acts for accomplishing a particular result. For example, FIGS. 8-10 illustrate flowcharts of example sequences or series of acts in accordance with one or more embodiments.

While FIGS. 8-10 illustrate acts according to particular embodiments, alternative embodiments may omit, add to, reorder, and/or modify any of the acts shown in FIGS. 8-10. The acts of FIGS. 8-10 are sometimes performed as part of a method. Alternatively, a non-transitory computer readable medium comprises instructions, that when executed by one or more processors, cause a computing device to perform the acts of FIGS. 8-10. In still further embodiments, a system performs the acts of FIGS. 8-10. Additionally, the acts described herein may be repeated or performed in parallel with one another or in parallel with different instances of the same or other similar acts.

FIG. 8 illustrates an example series of acts 800 for generating image layers from a digital image using a shape detection neural network, a solid fill algorithm, and a pixel color algorithm. In particular, the series of acts 800 includes an act 802 of detecting shapes depicted in a digital image. For example, the act 802 involves detecting, utilizing a shape detection neural network, one or more shapes depicted in a digital image. As shown, the series of acts 800 also includes an act 804 of identifying a background region in the digital image. For example, the act 804 involves identifying, from the one or more shapes depicted in the digital image, a background region comprising background pixels depicted in the digital image. In addition, the series of act 800 includes an act 806 of determining that the one or more shapes and/or the background region depict solid fill pixels. For example, the act 806 involves determining, utilizing a solid fill algorithm, that the background region depicts solid fill pixels. The series of acts 800 also includes an act 808 of determining a prominent color for the solid fill pixels. For instance, the act 808 involves determining, utilizing a prominent color algorithm, a prominent color for the solid fill pixels based on determining that the one or more shapes or the background region depicts solid fill pixels. Further, the series of acts 800 includes an act 810 of generating an image layer from the solid fill pixels. For example, the act 810 involves generating, from the prominent color, an image layer for the digital image. The act 810 includes extracting, from the digital image, an image layer comprising pixels with values indicated by the prominent color. In some embodiments, the act 810 includes extracting, from the digital image, an image layer for the shape depicted in the digital image and comprising pixels with values indicated by the prominent color.

In one or more embodiments, the series of acts 800 includes an act of detecting the one or more shapes by detecting a partially occluded shape depicted in the digital image utilizing the shape detection neural network. In some cases, the series of acts 800 includes an act of detecting the one or more shapes by utilizing the shape detection neural network to generate bounding boxes for the one or more shapes depicted in the digital image. The series of acts 800 further includes an act of identifying the background region by determining a set of pixels farthest from a viewpoint of a user viewing the digital image via a client device by removing the one or more shapes, detected objects, and detected text from the digital image.

In some embodiments, the series of acts 800 includes an act of determining that the background region depicts solid fill pixels by utilizing the solid fill algorithm to determine that at least a threshold percentage of pixels within in the background region depict values within a range corresponding to a common color label. In these or other embodiments, the series of acts 800 includes an act of determining the prominent color for the solid fill pixels by using the prominent color algorithm to: identify the prominent color as a color that satisfies a coverage threshold as part of the solid fill algorithm and validate the prominent color by comparing the prominent color with a converted version of the prominent color binned according to a hue value. In some cases, the series of acts 800 includes an act of generating, for the image layer, a modified background region by filling the background region with the prominent color.

In some embodiments, the series of acts 800 includes an act of identifying a shape comprising solid fill pixels from the one or more shapes depicted in the digital image. In addition, the series of acts 800 includes an act of determining a prominent color for the solid fill pixels by: converting a color value for the solid fill pixels from a first color space to a second color space and based on converting the color value, comparing the color value in the first color space to a color bin value converted from the second color space to the first color space. Further, the series of acts 800 includes an act of generating, from the prominent color, an image layer for shape depicted in the digital image.

In one or more embodiments, the series of acts 800 includes an act of determining the prominent color further by: determining, based on converting the color value from the first color space to the second color space, a color bin corresponding to a converted color value of the solid fill pixels and determining the color bin value associated with the color bin in the second color space. In some cases, the series of acts 800 includes an act of determining that the shape depicts solid fill pixels by determining that at least a threshold percentage of pixels within the shape have values within a range corresponding to a color label. In some embodiments, the series of acts 800 includes an act of detecting the one or more shapes by using the shape detection neural network to detect at least one occluded shape depicted in the digital image.

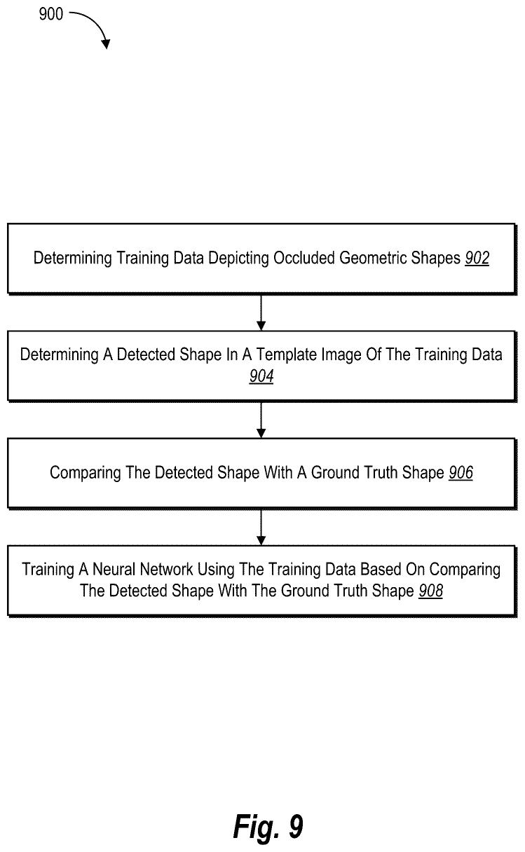

FIG. 9 illustrates an example series of acts 900 for training a neural network to detect shapes depicted in digital images. In particular, the series of acts 900 includes an act 902 of determining training data depicting occluded geometric shapes. For example, the act 902 involves determining training data comprising template images depicting occluded geometric shapes. In addition, the series of acts 900 includes an act 904 of determining a detected shape in a template image of the training data. For example, the act 904 involves determining, utilizing a neural network, a detected shape depicted in a template image of the training data. Additionally, the series of acts 900 includes an act 906 of comparing the detected shape with a ground truth shape. For instance, the act 906 involves comparing the detected shape with a ground truth shape corresponding to the template image within the training data. Further, the series of acts 900 includes an act 908 of training a neural network using the training data based on comparing the detected shape with the ground truth shape. For example, the act 908 involves training the neural network using the training data based on comparing the detected shape with the ground truth shape to generate a trained neural network that detects shapes in digital images.

In one or more embodiments, the series of acts 900 includes an act of determining the training data by: selecting, from an image database, template images depicting one or more of rectangles, ellipses, or triangles that are occluded by other objects depicted in the template images and determining ground truth shapes depicted in the template images. In addition, the series of acts 900 includes an act of determining the detected shape in the template image comprises utilizing the neural network to predict a label for at least one shape depicted in the template image according to parameters of the neural network.

In some embodiments, the series of acts 900 includes an act of comparing the detected shape with the ground truth shape by utilizing a loss function to determine a measure of loss between the detected shape and the ground truth shape. Additionally, the series of acts 900 includes an act of training the neural network by modifying parameters of the neural network to reduce the measure of loss. Further, the series of acts 900 includes an act of providing the neural network for implementation in predicting shapes depicted in one or more digital images.

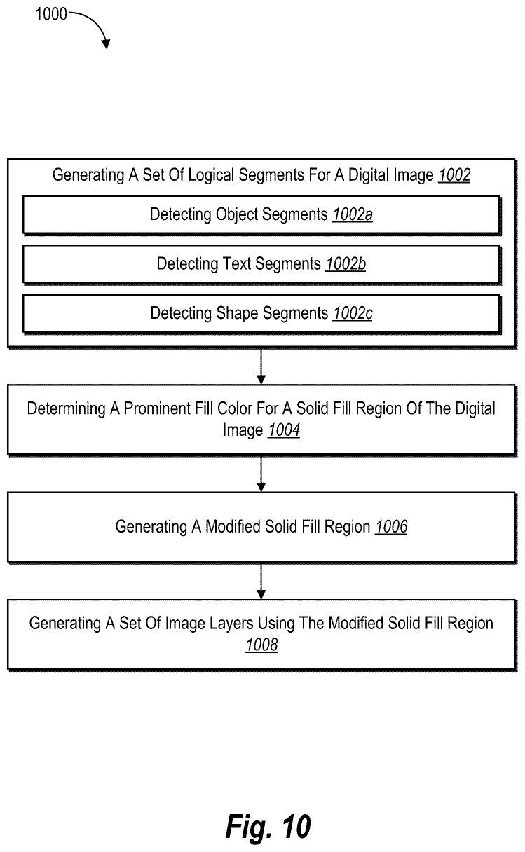

FIG. 10 illustrates an example series of acts 1000 for generating a set of image layers by extracting and processing logical segments of a digital image. In particular, the series of acts 1000 includes an act 1002 of generating a set of logical segments for a digital image. In some cases, the act 1002 includes an act 1002a of detecting object segments, an act 1002b of detecting text segments, and an act 1002c of detecting shape segments. For example, the act 1002a involves detecting object segments depicted in the digital image using an object segmentation model. In addition, the act 1002b involves extracting text segments depicted in the digital image using a text segmentation model. Further, the act 1002c involves detecting shape segments depicted in the digital image using a shape segmentation model.

In addition, the series of acts 1000 includes an act 1004 of determining a prominent fill color for a solid fill region of the digital image. For example, the act 1004 involves determining, based on the set of logical segments, a prominent color for a solid fill region of the digital image. Additionally, the series of acts 1000 includes an act 1006 of generating a modified solid fill region. For instance, the act 1006 involves generating a modified solid fill region by filling the solid fill region with the prominent color. In some embodiments, the series of acts 1000 includes an act 1008 of generating a set of image layers using the modified solid fill region. For example, the act 1008 involves generating, from the modified solid fill region, a set of image layers corresponding to the set of logical segments.

In one or more embodiments, the series of acts 1000 includes an act of detecting the shape segments depicted in the digital image by using a shape detection neural network trained to detected occluded shapes depicted in digital images based on a custom dataset. In addition, the series of acts 1000 includes an act of receiving, from a client device, a selection of an image layer corresponding to the modified solid fill region from among the set of image layers corresponding to the set of logical segments and an act of modifying the image layer in response to a user interaction with the client device.

In certain embodiments, the series of acts 1000 includes an act of identifying, from the set of logical segments, a background region comprising background pixels depicted in the digital image. In addition, the series of acts 1000 includes an act of determining the solid fill region of the digital image by determining the prominent color utilizing a solid fill algorithm.

In some embodiments, the series of acts 1000 includes an act of generating the modified solid fill region by: validating, using a prominent color algorithm, the prominent color by: generating a converted prominent color in an alternative color space, binning the converted prominent color according to the alternative color space, and comparing the converted prominent color with the prominent color. The series of acts 1000 also includes an act of filling the solid fill region with the prominent color based on validating the prominent color. In some embodiments, the series of acts 1000 includes an act of generating the set of image layers by: generating a background layer for the modified solid fill region, generating object layers for the object segments, generating text layers for the text segments, and generating shape layers for the shape segments.

Embodiments of the present disclosure may comprise or use a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) use transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., computing device 700, server device(s) 104, and/or client device 108). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 11, the components illustrated in FIG. 11 are not intended to be limiting. Additional or alternative components may be used in other embodiments. Furthermore, in certain embodiments, the computing device 1100 includes fewer components than those shown in FIG. 11. Components of the computing device 1100 shown in FIG. 11 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
detecting, utilizing a shape detection neural network, one or more shapes depicted in a digital image;
identifying, from the one or more shapes depicted in the digital image, a background region comprising background pixels depicted in the digital image;
determining that the background region depicts solid fill pixels;
determining a prominent color for the solid fill pixels based on determining that the background region depicts solid fill pixels; and
extracting, from the digital image, an image layer comprising pixels with values indicated by the prominent color.

2. The method of claim 1, wherein detecting the one or more shapes comprises detecting a partially occluded shape depicted in the digital image utilizing the shape detection neural network.

3. The method of claim 1, wherein detecting the one or more shapes comprises utilizing the shape detection neural network to generate bounding boxes for the one or more shapes depicted in the digital image.

4. The method of claim 1, wherein identifying the background region comprises determining a set of pixels farthest from a viewpoint of a user viewing the digital image via a client device by removing the one or more shapes, detected objects, and detected text from the digital image.

5. The method of claim 1, wherein determining that the background region depicts solid fill pixels comprising utilizing a solid fill algorithm to determine that at least a threshold percentage of pixels within in the background region depict values within a range corresponding to a common color label.

6. The method of claim 1, wherein determining the prominent color for the solid fill pixels comprises using a prominent color algorithm to:
identify the prominent color as a color that satisfies a coverage threshold as part of a solid fill algorithm; and
validate the prominent color by comparing the prominent color with a converted version of the prominent color binned according to a hue value.

7. The method of claim 1, further comprising generating, for the image layer, a modified background region by filling the background region with the prominent color.

8. A system comprising:
a memory component; and
one or more processing devices coupled to the memory component, the one or more processing devices to perform operations comprising:
detecting, utilizing a shape detection neural network, one or more shapes depicted in a digital image;
identifying a shape comprising solid fill pixels from the one or more shapes depicted in the digital image;
determining a prominent color for the solid fill pixels; and
extracting, from the digital image, an image layer for the shape depicted in the digital image and comprising pixels with values indicated by the prominent color.

9. The system of claim 8, wherein determining the prominent color comprises:
determining, based on converting a color value of the solid fill pixels from a first color space to a second color space, a color bin corresponding to a converted color value of the solid fill pixels; and
determining a color bin value associated with the color bin in the second color space.

10. The system of claim 8, wherein the operations further comprise determining that the shape depicts solid fill pixels by determining that at least a threshold percentage of pixels within the shape have values within a range corresponding to a color label.

11. The system of claim 8, wherein detecting the one or more shapes comprises using the shape detection neural network to detect at least one occluded shape depicted in the digital image.

12. The system of claim 8, wherein the operations further comprise training the shape detection neural network using training data comprising template images depicting occluded geometric shapes.

13. The system of claim 12, wherein the operations further comprise determining the training data by:
selecting, from an image database, template images depicting one or more of rectangles, ellipses, or triangles that are occluded by other objects depicted in the template images; and
determining ground truth shapes depicted in the template images.

14. A non-transitory computer readable medium storing instructions which, when executed by a processing device, cause the processing device to perform operations comprising:
generating a set of logical segments from a digital image by:
detecting object segments depicted in the digital image using an object segmentation model;
extracting text segments depicted in the digital image using a text segmentation model; and
detecting shape segments depicted in the digital image using a shape segmentation model;
determining, based on the set of logical segments, a prominent color for a solid fill region of the digital image;
generating a modified solid fill region by filling the solid fill region with the prominent color; and
generating, from the modified solid fill region, a set of image layers corresponding to the set of logical segments.

15. The non-transitory computer readable medium of claim 14, wherein detecting the shape segments depicted in the digital image comprises using a shape detection neural network trained to detected occluded shapes depicted in digital images based on a custom dataset.

16. The non-transitory computer readable medium of claim 14, wherein the operations further comprise:
receiving, from a client device, a selection of an image layer corresponding to the modified solid fill region from among the set of image layers corresponding to the set of logical segments; and
modifying the image layer in response to a user interaction with the client device.

17. The non-transitory computer readable medium of claim 14, wherein the operations further comprise identifying, from the set of logical segments, a background region comprising background pixels depicted in the digital image.

18. The non-transitory computer readable medium of claim 17, wherein the operations further comprise determining the solid fill region of the digital image by determining the prominent color utilizing a solid fill algorithm.

19. The non-transitory computer readable medium of claim 14, wherein generating the modified solid fill region comprises:
validating, using a prominent color algorithm, the prominent color by:
generating a converted prominent color in an alternative color space;
binning the converted prominent color according to the alternative color space; and
comparing the converted prominent color with the prominent color; and
filling the solid fill region with the prominent color based on validating the prominent color.

20. The non-transitory computer readable medium of claim 14, wherein generating the set of image layers comprises:
generating a background layer for the modified solid fill region;
generating object layers for the object segments;
generating text layers for the text segments; and
generating shape layers for the shape segments.
